(19) United States
(12) Patent Application Publication
(10) Pub. No.: US 2002/0109984 A1
(43) Pub. Date: Aug. 15, 2002

(54) Electrified ceiling truss

(76) Inventors: Wesley T.K. Bischel, Lancaster, PA (US); James F. Mathis, Lancaster, PA (US); Richard D. Stackenwalt, Dallastown, PA (US)

Correspondence Address: Womble Carlyle Sandridge & Rice, PLLC, P.O. Box 7037, Atlanta, GA, 30357-0037, US

(21) Appl. No.: 10/002,076

(22) Filed: Nov. 1, 2001

Related U.S. Application Data
(60) Provisional application No. 60/245,469, filed on Nov. 3, 2000.

(51) Int. Cl. F21S 8/00

(52) U.S. Cl. 362/150; 362/391; 362/404; 362/407

(57) ABSTRACT

Disclosed is an apparatus and method for providing support for a suspended ceiling system and movable lighting for a room. The apparatus essentially comprises a ceiling truss having a main beam and at least one standoff connected to and projecting laterally from the main beam. A truss cable is anchored at the ends of the beam and extends over the standoff to form a cable truss configuration for providing support to the beam. The truss cable can be electrified, wherein a lighting fixture may be attached to adjacent cables for illuminating a room below.

### CROSS-REFERENCE TO RELATED APPLICATION

This application claims the benefit of provisional application serial No. 60/245,469, filed on Nov. 3, 2000.

### FIELD OF INVENTION

The present invention relates generally to suspended ceiling systems and more particularly to support grids of suspended ceiling systems.

### BACKGROUND

Current business practices require workspaces that can easily be reconfigured to suit the differing needs and ever changing business practices of corporate tenants and their employees. Whether it is office, manufacturing, engineering, meeting or equipment space, contemporary building designs must allow for easy adaptation of interiors to suit such diverse needs. This is true both for spaces leased to tenants aid spaces within corporate facilities where organizational change and new ways of doing business must be accommodated. This configuration flexibility requirement extends both to suspended ceiling systems and lighting systems.

Typical suspended ceiling systems are built around a suspended grid. A series of hanger wires, typically 12-gauge in size, are attached to the hard ceiling of a room at regular 4-foot intervals, as determined by national codes. The hanger wires suspend a grid comprising spaced apart steel main beams, each in the shape of an inverted “T”, or any other known ceiling grid profile such as a “C” channel or bandraster, and a number of cross tee elements spanning the main beams to form a grid-work of openings. Ceiling components, such as acoustic tiles, lighting fixtures, and diffusers are placed within the grid-work openings to form the ceiling. The ceiling is further supported at the perimeter walls by L-shaped metal brackets or support strips.

The components for a traditional suspended ceiling are fabricated in a manner that balances the thickness of the metal used for the grid beam elements with the anticipated distance between hanger wires of 48 inches, and the anticipated load on the beam elements. The load capacity of the grid is calculated with a safety factor to reduce deflection caused by the weight of the ceiling tiles and other fixtures. The suspension wire span of 48 inches on center is considered a standard, and is unlikely to change. To increase load capacity, manufacturers typically utilize a heavier gauge metal base material for the main beam elements and manufacture them to be taller.

Some suspended ceiling applications may not permit the installation of grid hanger wires at four-foot intervals, as traditional practice and many building codes dictate. This limits design options and may preclude the use of a suspended ceiling system in an area where it would be desirable. Further, even in situations where hanger wires may be more than four feet apart, spans of greater than about six feet usually require specially reinforced or heavier, more expensive grid components. The spanning of an entire room generally has not been feasible even with the heaviest gauge beams. What is needed, therefore, is a way to span greater distances with unsupported grid-work beams, including spanning the entire width of a room, without resorting to specially-designed heavy-duty beams.

Additionally, low voltage lighting systems for both direct and indirect illumination, are in vogue with many designers. They are favored in many cases for their flexibility and lack of constraining electrical code restrictions, when compared to high voltage systems. Indirect, pendant, and other styles of low voltage lighting fixtures that are installed below the ceiling plane bring light sources closer to work areas and improve contrast ratios. Unfortunately, low voltage lighting fixtures, like their high voltage counterparts, have heretofore been relatively fixedly attached to ceiling structures and thus not easily reconfigurable, at least without the aid and skill of a professional electrician. Thus, there is a need for easily user reconfigurable low voltage lighting systems for workspaces.

Therefore, there is a need both for unsupported extended spans of suspending ceiling beams that do not require suspension cables every four feet and easily configurable low voltage electrical lighting fixtures for mounting below the plane of a suspended ceiling. It is to the satisfaction of these needs that the present invention is primarily directed.

### SUMMARY

Briefly described, the present invention is an apparatus and method for providing for extended spans of unsupported ceiling system grid-work and also selectively movable low voltage lighting for a room. The apparatus essentially comprises a main beam for use in a suspended ceiling grid that has at least one and preferably a spaced pair of depending standoffs connected to the main beam. One or more truss cables are anchored at the ends of the beam and substantially span the length of the main beam. The truss cable extends across the depending standoffs, which space the truss cable below the main beam in the region between the standoffs. The truss cable and the beam thus form a self supporting truss configuration, which is capable of supporting itself across extended spans without suspension wires. Further, the truss cables of a single beam or two adjacent beams in a suspended ceiling grid-work can be electrified along with providing support for the extended main beam. A lamp may then be attached to the electrified cables to provide lighting for the room below. The lamp preferably is a low voltage lighting fixture and is attached between the electrified truss cables of two adjacent main beams. The cables preferably are coupled to a low voltage transformer for supplying low voltage power to the operation of light fixtures.

In use, a suspended ceiling grid-work is formed by a plurality of spaced cable truss supported main beams spanning the width of a room and supporting themselves without suspension wires. Alternatively, the cable truss supported main beams can span between and attach to opposite partitions or movable wall elements. Since the present suspended ceiling grid-work does not require suspension wires, it can easily be used, for example, in a temporary office space or conference room built in the middle of a warehouse or open office space using movable wall partitions.

Traditional cross tees extend between the main beams to form openings. Ceiling tiles are mounted in the openings in the traditional way to form the ceiling plane. Alternatively, long, narrow ceiling panels (commonly referred to as planks which are typically 12 inches wide and vary in length from 2 feet to 8 feet) can be used to span between the cable trusses and the perimeter walls of the modular office spaces. With the truss cables of adjacent main beams provided with low voltage electrical power, low voltage lighting fixtures can be attached between adjacent truss cables to provide desired lighting. The lighting is easily configurable and reconfigurable simply by detaching the fixtures and attaching them at another location.

Thus, an improved suspended ceiling system is now provided that can span relatively long distances without suspension wires and that simultaneously provides easily reconfigurable low voltage lighting. These and other features, objects, and advantages of the invention will become more apparent upon review of the detailed description set forth below taken in conjunction with the accompanying drawing figures, which are briefly described as follows.

### BRIEF DESCRIPTION OF THE DRAWINGS

FIG. 1 is a perspective view of a suspended ceiling beam and truss cable embodying a “T” profile, a “C” profile and a bandraster configuration.

FIG. 2 is a side elevational view of a suspended ceiling main beam fitted in place between two walls with perimeter strips and wall mountings.

FIG. 3 is a perspective illustration of two substantially parallel electrified suspended ceiling beams with a low voltage light fixture connected between the two truss cables of the beams and a further embodiment illustrates a beam supporting one truss cable, an electrical wire parallel to the truss cable and a low voltage light fixture.

FIG. 4 illustrates the electrified truss cables and attached low voltage lighting fixture.

FIG. 5 illustrates a bandraster configuration with two truss cables on one element.

### DETAILED DESCRIPTION

The present invention comprises a method and apparatus for extending the span of a suspended ceiling main beam without resorting to heavy duty beam construction. The apparatus and method provide both self support for ceiling grid-work and a movable lighting system for a room. The apparatus essentially comprises a suspended ceiling main beam and at least one and preferably a pair of standoffs depending from the main beam. A truss cable is anchored at the ends of the beam and extends across the standoffs to form a cable truss structure for supporting the main beam across an extended span without separate suspension wires. The truss cables of adjacent beams can be electrified for attaching a low voltage lamp to the cables for illuminating a room below.

The span of the main beam is increased by the addition of truss cables such that the beam can span a distance greater than 12 feet without the need for suspension wires. Additionally, the truss cables can be electrified by a low voltage power source for providing power to lamps attached between adjacent cables. The lamps or lighting fixtures can then be used either as task lighting or for general purpose lighting of an interior and are easily reconfigurable as needed.

The cable truss supported main beam forms part of a traditional support grid of a suspended ceiling. A plurality of truss supported main beams and cross beams interconnect to form a support grid with rectangular or square openings in much the same way as a traditional suspended ceiling, wherein the main beams are traditionally supported by wires from above. The grid supports conventional ceiling tiles which rest within the openings of the grid. The ceiling tiles can be acoustical ceiling tiles or panels which are acoustically absorbent and can be formed from conventional materials such as organic matter, including cellulose, mineral fiber, fiberglass, metal or combinations thereof.

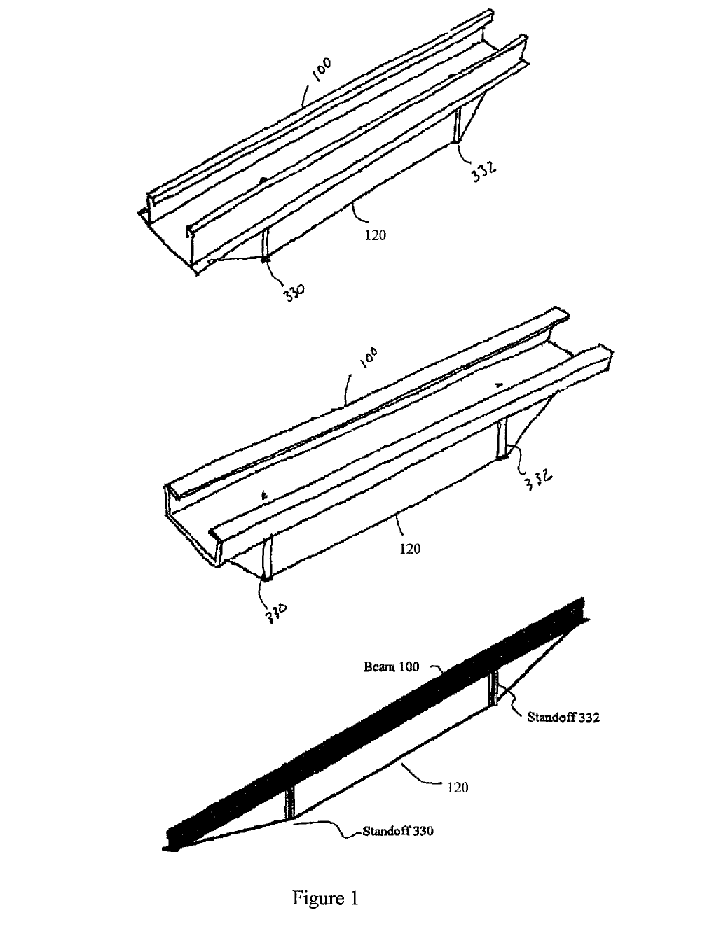

Referring now in more detail to the drawings, wherein like numerals refer to like parts throughout the several views, FIG. 1 illustrates the basic elements of the invention, including the main beam 100, a truss cable 120, and a pair of standoffs 330, 332. There may be only one standoff if desired.

The main beam 100 may have most any shape applicable for supporting a plurality of ceiling panels. The main beam 100 is depicted in FIG. 1 as having a “T” profile, a “C” profile and as a bandraster. Essentially, the main beam 100 functions as a compression member with the truss cable 120 functioning as a tensioning member.

The cable 120 preferably is mechanically attached or otherwise anchored at each end of the main beam 100. The first standoff 330 is interposed between the cable 120 and the main beam 100, and typically is located some distance from an end of the main beam 100. An optional second standoff 332 also is typically interposed between the cable 120 and the main beam 100, and typically is spaced a similar distance as the first standoff from the opposite end of the main beam 100. The truss cable 120 extends across the ends of the standoffs and is thus supported by the standoffs at a spaced distance below the main beam.

The truss cable preferably is made from an electrically conductive material such as steel and is tensioned to form a cable truss support structure for the main beam. By placing the cable 120 in tension, an upward force is generated against the main beam 100 in the location of each standoff 330, 332. This force counteracts downward loading on the main beam 100, permitting a balancing of the load and reduction of the deflection of the main beam 100. The tension under which the cable is placed can be selected to provide the proper support for any given span and expected loading on the beam.

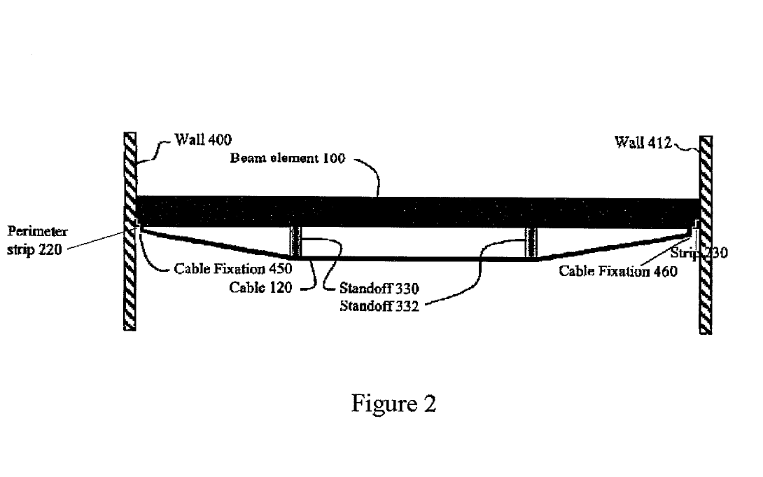

FIG. 2 illustrates a cable truss supported main beam spanning two opposing walls of a building. The first wall 410 defines one boundary of a space in which the suspended ceiling is to be installed, and generally is perpendicular to the direction of the main beams of the ceiling grid. The second wall 412 is opposite the first wall at the opposite boundary of the space. A first perimeter support strip 220 provides an L-shaped perimeter support along the first wall 410. A second perimeter support strip 230 is also provided, similar to the first strip 220, and provides an L-shaped perimeter support along the second wall 412. First and second cable anchoring devices 450, 460 are provided for attachment to the ends of the ceiling beam truss for anchoring the ends of a truss cable 120. The first perimeter strip 220 is preferably mechanically attached to the first wall 410 and the second perimeter strip 230 is mechanically attached to the second wall 412.

The main beam 100 is supported at each end and attached to the perimeter support strips 220, 230. The truss cable 120 extends from cable anchors 450, 460 across the free lower ends of the standoffs 330, 332, which space the truss cable from the main beam to form a cable truss support for the main beam. When tensioned, the truss cable exerts upward force on the main beam through the standoffs to support the weight of the beam and other ceiling components mounted thereto. Thus, the main beam may span the entire distance between the walls 400, 412 without the need for traditional suspension cables.

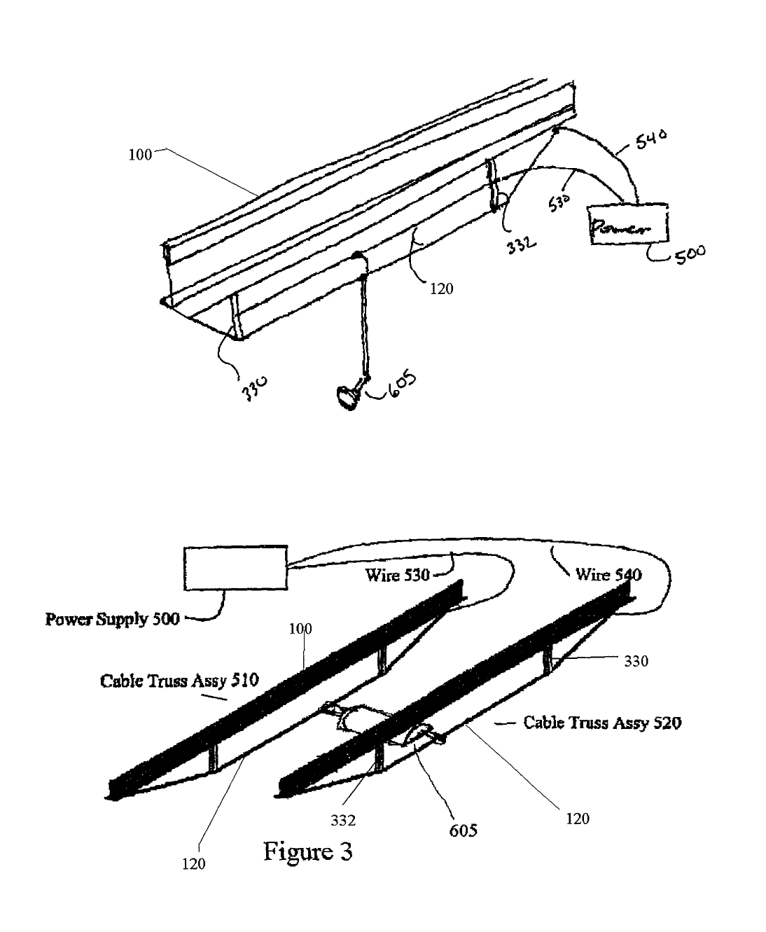

A further aspect is illustrated in FIG. 3, which shows two adjacent cable truss supported beams as they might appear in a suspended ceiling. A first cable truss assembly 510 includes a main beam 100, truss cable 120, standoffs 330, 332. Additionally, perimeter support strips 220, 230 and cable anchors 450, 460 may also be added to the truss assembly which are not shown in FIG. 3 but are illustrated in FIG. 2. Similarly, the second cable truss assembly 520 includes these same elements. The truss cable 120 is an electrical conductor of sufficient gauge to provide power to lighting and other devices that might be attached between the two truss cables.

Further illustrated in FIG. 3 is an embodiment having a single main beam 100, standoffs 330, 332, a pair of cables 120 supporting a low voltage lighting fixture 605. The cables can be configured such that a first cable acts as a support truss cable and is connected to the main beam 100. The second cable can be connected to the standoffs 330, 332. The low voltage lighting fixture 605 can be releasably attached between the pair of cables 120, which supply low voltage operating power to the fixture. Power can be supplied to the cables 120 by a power supply 500.

First and second electrical connector wires 530, 540 are coupled to a power supply 500 and are connected to respective ones of the cables to electrify the cables with low voltage power compatible with low voltage lighting fixtures. The power supply 500 is electrically connected to the first truss cable assembly 510 by the first wire 530 and to the second truss cable 520 by the second wire 540. The power supply 500 preferably is mechanically mounted above the ceiling plane in a convenient location. A low voltage lighting fixture 605 is releasably attached between the truss cables, which supply low voltage operating power to the fixture. The fixture can take on any of a number of configurations including direct lighting fixtures, indirect lighting fixtures, spot lights, or otherwise. Further, the fixtures can be added and removed at will by attaching them to and detaching them from the truss cables of the ceiling system.

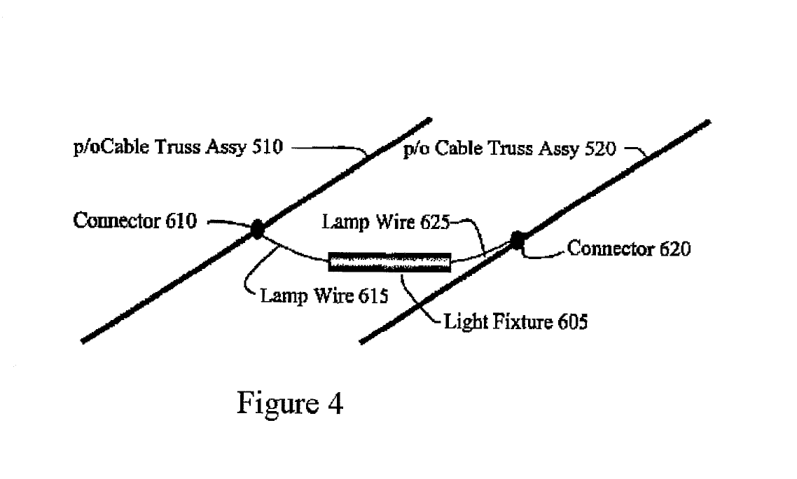

FIG. 4 illustrates the attachment of a lighting fixture 605 between two adjacent truss cables 510, 520. The light fixture 605 may be any suitable lighting fixture of a size and weight that is readily supported by the truss cables. The first lamp wire 615 as a conductor and support wire may or may not be insulated. A first connector and second connector 610, 620 may be a clamp, clip, or other connector that provides an electrically conductive path from the cable assembly to the lamp wire to which it is attached. One example may be an “alligator clip.”

The light fixture 605 is electrically connected to the first connector 610 by the first lamp wire 615. The light fixture 605 is electrically connected to the second connector 620 by the second lamp wire 625. The first connector 610 is electrically and mechanically attached to the first cable assembly 520. In this way, electrical power is provided to the lamp fixture 605 by the power supply 500.

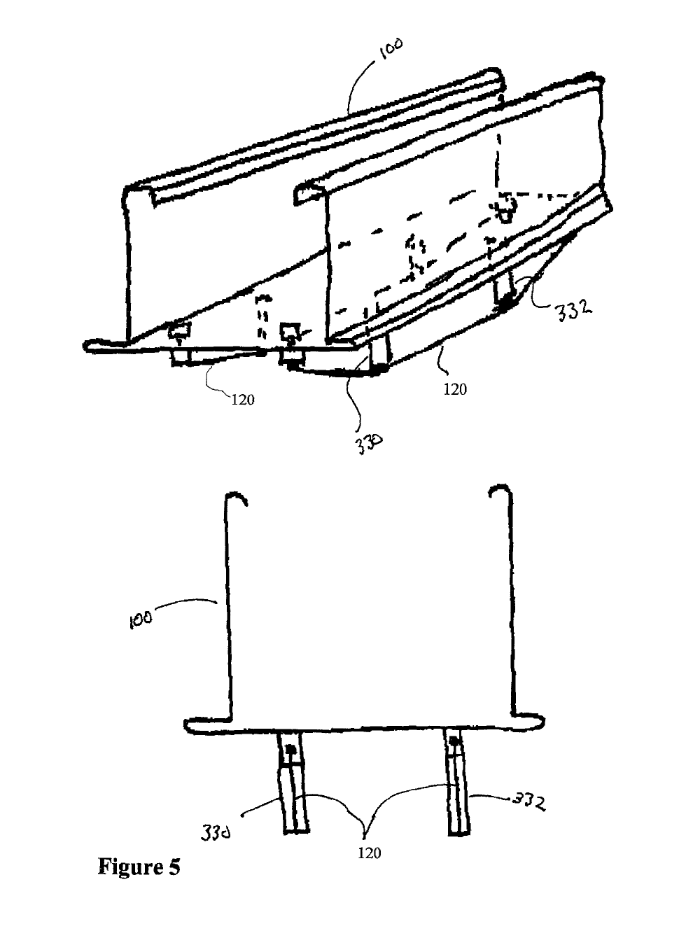

Illustrated in FIG. 5 is a bandraster configuration having a main beam 100 with two substantially parallel truss cables 120. The truss cables 120 are each supported by separate standoffs 330, 332 and are positioned substantially parallel in a plane horizontal to the underside of the main beam 100.

In an alternative embodiment, the described cable assembly can be installed for the sole purpose of providing a lighting solution, where additional structural support may not be required. Thus, the cable truss support beam need not be part of a suspended ceiling system but rather simply may be a part of an easily configurable low voltage lighting system.

While preferred embodiments have been illustrated and described above, it is recognized that variations may be made with respect to features and components of the invention. Therefore, while the invention has been disclosed in preferred forms only, it will be obvious to those skilled in the art that many additions, deletions and modifications can be made therein without departing from the spirit and scope of this invention, and that no undue limits should be imposed thereon except as set forth in the following claims.

What is claimed is:

1. A suspended ceiling element comprising:
a main beam;
at least a first standoff connected to and projecting from the main beam; and
a first cable anchored to the main beam near the ends of the main beam and extending over the standoff, the cable substantially spanning the length of and providing support to the main beam.

2. The element of claim 1, wherein the cable is anchored at the ends of the main beam.

3. The element of claim 1, wherein the main beam has a cross-section selected from the group consisting of “T” profile, “C” profile and bandraster.

4. The element of claim 1, further including a lamp attached to the cable.

5. The element of claim 4, wherein the lamp comprises a low voltage light fixture.

6. The element of claim 1, further comprising a second standoff connected to and projecting from the main beam and a second cable anchored near the ends of the main beam and extending over the second standoff, the second cable being substantially parallel to the first cable and substantially spanning the length of and providing support to the main beam.

7. The element of claim 6, wherein a lamp is attached to the first cable and the second cable.

8. The element of claim 1, wherein the element includes a second standoff connected to and projecting from the main beam, the first and second standoffs being spaced apart, the truss cable extending over the first and the second standoff;
wherein a second cable is attached to the first and the second standoffs and is substantially parallel to the first cable truss, and electrically isolated from the first cable; and
wherein a lamp is attached to the first and the second substantially parallel cables.

9. The element of claim 1, further including a power supply electrically coupled to the cable.

10. The element of claim 9, further including a transformer electrically connected to the electrified cable.

11. The element of claim 1, wherein the main beam spans at least 12 feet.

12. The element of claim 1, wherein the cable is tensioned.

13. The element of claim 1, wherein the main beam further supports a plurality of ceiling panels.

14. A ceiling system comprising:
(a) a plurality of cable truss assemblies, each assembly including,
(1) a main beam,
(2) at least one standoff support connected to and projecting from the main beam, and
(3) a cable in communication with the standoff and substantially spanning the length of the main beam;
(b) a plurality of cross beams running substantially perpendicular to and in communication with the main beam to form a grid; and
(c) a ceiling panel supported by the grid.

15. The ceiling system of claim 14, wherein the ceiling panel comprises matter selected from the group consisting of organic matter, mineral fiber, fiberglass, metal and combinations thereof.

16. The ceiling system of claim 14, further including a lamp attached to the cable.

17. A ceiling system comprising:
(a) a plurality of cable truss assemblies, each assembly including,
(1) a main beam,
(2) at least one standoff support connected to and projecting from the main beam, and
(3) a cable in communication with the standoff and substantially spanning the length of the main beam; and
(b) a plurality of plank elements spanning between the main beams.

18. The ceiling system of claim 17, wherein the plank elements comprise matter selected from the group consisting of organic matter, mineral fiber, fiberglass, metal and combinations thereof.

19. The ceiling system of claim 17, further including a lamp attached to the cable.
